(19) United States
(12) Patent Application Publication
(10) Pub. No.: US 2015/0184942 A1
(43) Pub. Date: Jul. 2, 2015

(54) SYSTEM AND METHOD FOR DIRECTLY USING WASTE HEAT FROM HIGH TEMPERATURE SOLID

(71) Applicant: NATIONAL CHENG KUNG UNIVERSITY, Tainan City (TW)

(72) Inventors: Fu-Su YEN, Tainan City (TW); Chih-Cheng CHEN, Tainan City (TW); Pei-Ching YU, Yilan County (TW)

(21) Appl. No.: 14/543,900

(22) Filed: Nov. 18, 2014

(30) Foreign Application Priority Data
Dec. 27, 2013 (TW) 102148734

(51) Int. Cl. F27D 17/00; F27D 9/00

(52) U.S. Cl. CPC F27D 17/004; F27D 9/00; F27D 2009/0091

(57) ABSTRACT

A system and a method for directly using waste heat from a high temperature solid are provided. The system includes a first transverse hollow cylinder and a second transverse hollow cylinder disposed in the first transverse hollow cylinder. In the method, a first material is inputted into the first transverse hollow cylinder, and a second material is inputted into the second transverse hollow cylinder. Thereafter, the first material and the second material are outputted and collected respectively, in which the temperature of the input first material is greater than the temperature of the output first material, and the degree of moisture of the input second material is higher than that of the output second material.

### RELATED APPLICATIONS

This application claims priority to Taiwan Application Serial Number 102148734, filed Dec. 27, 2013, which is herein incorporated by reference.

### BACKGROUND

1. Field of Invention

The present invention relates to a system and a method for directly using waste heat. More particularly, the present invention relates to a system and a method for directly using waste heat from a high temperature solid.

2. Description of Related Art

In many existing mineral processes, a large amount of heat is generally required for the reactions of raw materials when many minerals are produced, thereby forming respective target minerals. For example, in a cordierite process, cordierite is produced mainly by performing a solid-state reaction under a high temperature of 1300° C. to 1350° C. for tens of hours.

A mineral product produced by a high temperature process has a high temperature of thousands degrees Centigrade when being produced. When the mineral product contacts room-temperature air, heat of thousands degrees centigrade is emitted until the temperature of the mineral is lowered to the room temperature, thus causing the ambient temperature to be raised and the heat generated from the mineral product to be wasted.

### SUMMARY

Therefore, an object of the present invention is to provide a system and a method for directly using waste heat generated from a high temperature solid, thereby effectively using the heat of the high temperature solid itself as a heat source to dry another product.

To achieve the aforementioned object, according to an embodiment of the present invention, a system for directly using waste heat generated from a high temperature solid is provided. The system includes a first transverse hollow cylinder and a second transverse hollow cylinder. The first transverse hollow cylinder has a first end, a second end opposite to the first end, a first material inlet, a first material outlet and a first auxiliary power apparatus. The second transverse hollow cylinder is disposed in the first transverse hollow cylinder. The second transverse hollow cylinder has a third end, a fourth end opposite to the third end, a second material inlet, a second material outlet and a second auxiliary power apparatus, in which the first end of the first transverse hollow cylinder is elevated higher than the second end of the first transverse hollow cylinder. The first material inlet is disposed near the first end and on a top of the first transverse hollow cylinder for inputting a first material. The first material outlet is disposed near the second end and at a bottom of the first transverse hollow cylinder for outputting the first material after being cooled, in which the bottom of the first transverse hollow cylinder is a side of the first transverse hollow cylinder near a ground. The first auxiliary power apparatus is connected to the first transverse hollow cylinder for vibrating or rotating the first transverse hollow cylinder. The fourth end of the second transverse hollow cylinder is elevated higher than the third end of the second transverse hollow cylinder, and the third end of the second transverse hollow cylinder extends out of the first end of the first transverse hollow cylinder. The second material inlet is disposed on the fourth end of the second transverse hollow cylinder for inputting a second material. The second material outlet is disposed on the third end of the second transverse hollow cylinder for outputting the second material after being dried. The second auxiliary power apparatus is connected to the second transverse hollow cylinder for vibrating or rotating the second transverse hollow cylinder.

According to another embodiment of the present invention, the aforementioned system further include a first material collecting device and a second material collecting device, in which the first material collecting device is disposed beneath the first material outlet and the second collecting device is disposed beneath the second material outlet.

According to another embodiment of the present invention, the aforementioned first transverse hollow cylinder further include a first rotation pivot disposed on a bottom of the first end or the second end of the first transverse hollow cylinder for adjusting an elevation of the second end or the first end.

According to another embodiment of the present invention, the aforementioned second transverse hollow cylinder further includes a second rotation pivot. The second rotation pivot is disposed at a bottom of the third end or the fourth end of the second transverse hollow cylinder, and is used to adjust an elevation of the fourth end or the third end of the second transverse hollow cylinder.

According to another embodiment of the present invention, the aforementioned system further includes a heat insulation sleeve covering at least one portion of an outer wall of the first transverse hollow cylinder.

According to another aspect of the present invention is to provide a method for directly using waste heat generated from a high temperature solid, thereby directly using the waste heat from the aforementioned system. In the method, the aforementioned first transverse hollow cylinder and second transverse hollow cylinder are provided at first. Then, the first material is inputted into the first transverse hollow cylinder through the first material inlet and the second material is inputted into the second transverse hollow cylinder through the second material inlet. Next, the first material is collected from the first material outlet and the second material is collected from the second material outlet.

According to another embodiment of the present invention, the aforementioned method further include adjusting an elevation of the first end or the second end of the first transverse hollow cylinder to change a moving speed of the first material from the first material inlet to the first material outlet.

According to another embodiment of the present invention, the aforementioned method further include vibrating or rotating the first transverse hollow cylinder to accelerate moving the first material from the first material inlet to the first material outlet.

According to another embodiment of the present invention, the aforementioned method further include adjusting an elevation of the third end or the fourth end of the second transverse hollow cylinder to change a moving speed of the second material from the second material inlet to the second material outlet.

According to another embodiment of the present invention, the aforementioned method further include vibrating or rotating the second transverse hollow cylinder to accelerate moving the second material from the second material inlet to the second material outlet.

### BRIEF DESCRIPTION OF THE DRAWINGS

The invention can be more fully understood by reading the following detailed description of the embodiment, with reference made to the accompanying drawings as follows:

FIG. 1 is a schematic cross-sectional view of a system for directly using waste heat from a high temperature solid according to one embodiment of this invention; and

FIG. 2 is a flow chart of a method for directly using waste heat from a high temperature solid according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

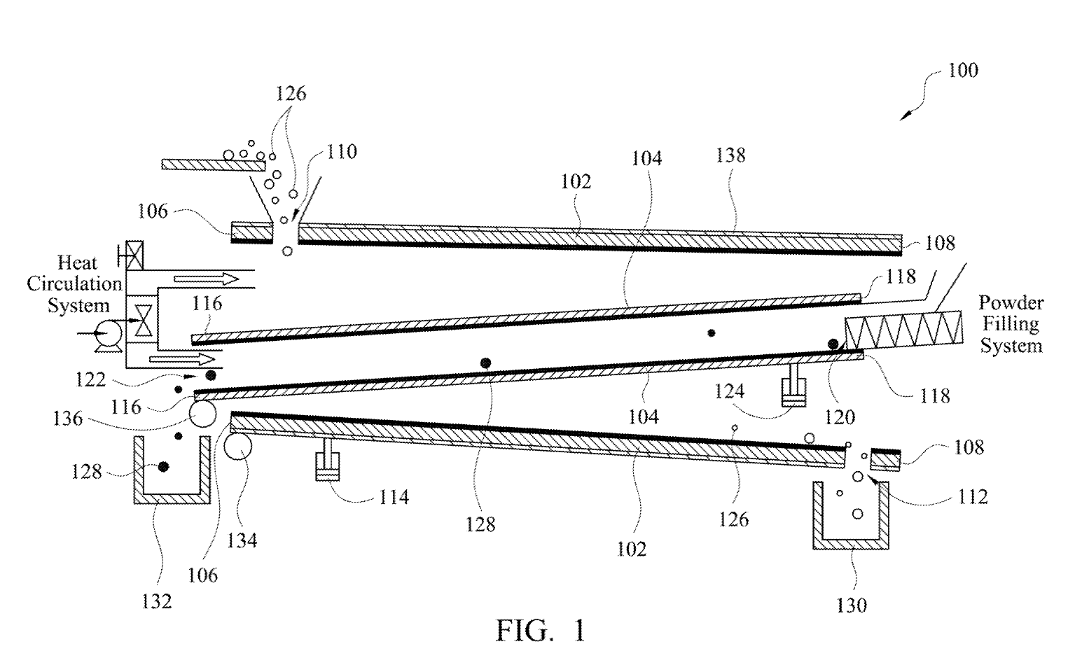

Referring to FIG. 1, FIG. 1 is a schematic cross-sectional view of a system 100 for directly using waste heat from a high temperature solid according to one embodiment of this invention. The system 100 includes a first transverse hollow cylinder 102 and a second transverse hollow cylinder 104. The first transverse hollow cylinder 102 has a first end 106 and a second end 108 opposite to the first end 106, a first material inlet 110, a first material outlet 112 and a first auxiliary power apparatus 114. The first end 106 of the first transverse hollow cylinder 102 is elevated higher than the second end 108 of the first transverse hollow cylinder 102. The first material inlet 110 is disposed near the first end 106 of the first transverse hollow cylinder 102 and on a top of the first transverse hollow cylinder 102. The first material outlet 112 is disposed near the second end 108 and at a bottom of the first transverse hollow cylinder 102, in which the bottom of the first transverse hollow cylinder 102 is a side of the first transverse hollow cylinder 102 near a ground. The first auxiliary power apparatus 114 is connected to the first transverse hollow cylinder 102 for vibrating or rotating the first transverse hollow cylinder 102. In an embodiment, the first auxiliary power apparatus 114 is a vibrating tool used for vibrating the first transverse hollow cylinder 102. In another embodiment, the auxiliary power apparatus 114 is a rotating tool used for rotating the first transverse hollow cylinder 102. In another embodiment, at least one portion of an outer wall of the first transverse hollow cylinder 102 is covered by a heat insulation sleeve 138.

In an embodiment, the first transverse hollow cylinder 102 further includes a first rotation pivot 134 used to adjust an inclined angle of the first transverse hollow cylinder 102. The first rotation pivot 134 is disposed at a bottom of the first end 106 of the first transverse hollow cylinder 102 to adjust the elevation of the second end 108. In another embodiment, the first rotation pivot 134 can be disposed at the bottom of the second end 108 of the first transverse hollow cylinder 102 to adjust the elevation of the first end 106 of the first transverse hollow cylinder 102.

In an embodiment, a first material 126 is a high temperature solid. The first material 126 can be such as a mineral product formed in a mineral process. The first material 126 is inputted into the first transverse hollow cylinder 102 from the top of the first transverse hollow cylinder 102 through the first material inlet 110 disposed near the first end 106 of the first transverse hollow cylinder 102, and falls onto the bottom of the first transverse hollow cylinder 102 due to gravity. By using the operation of the first auxiliary power apparatus 114 with the inclination of the first transverse hollow cylinder 102, the first material 126 can be moved inside the first transverse hollow cylinder 102 and emit heat. After being cooled and moved to the first material outlet 112, the first material 126 is outputted from the first material outlet 112.

The second transverse hollow cylinder 104 is disposed in the first transverse hollow cylinder 102, and has a third end 116, a fourth end 118 opposite to the third end 116, a second material inlet 120, a second material outlet 122 and a second auxiliary power apparatus 124. The fourth end 118 of the second transverse hollow cylinder 104 is elevated higher than the third end 116 of the second transverse hollow cylinder 104, and the third end 116 extends out of the first end 106 of the first transverse hollow cylinder 102. The second material inlet 120 is disposed on the fourth end 118 of the second transverse hollow cylinder 104 for inputting a second material 128 (for example, a product desired to be dried). The second material outlet 122 is disposed on the third end 116 of the second transverse hollow cylinder 104 for outputting the second material 128 after being dried. The second auxiliary power apparatus 124 is connected to the second transverse hollow cylinder 104. In an embodiment, the second auxiliary power apparatus 124 is a vibrating tool used for vibrating the second transverse hollow cylinder 104. In another embodiment, the second auxiliary power apparatus 124 is a rotating tool used for rotating the second transverse hollow cylinder 104.

The second transverse hollow cylinder 104 further includes a second rotation pivot 136 used to adjust an inclined angle of the second transverse hollow cylinder 104. The second rotation pivot 136 is disposed at the bottom of the third end 116 of the second transverse hollow cylinder 104, and is used to adjust the elevation of the fourth end 118 of the second transverse hollow cylinder 104. In another embodiment, the second rotation pivot 136 is disposed at the bottom of the fourth end 118 of the second transverse hollow cylinder 104, and is used to adjust the elevation of the third end 116 of the second transverse hollow cylinder 104.

In an embodiment, the second material 128 is a high-water content material. The second material 128 is inputted into the second transverse hollow cylinder 104 through the second material inlet 120 of the fourth end 118, and falls onto the bottom of the second transverse hollow cylinder 104 due of gravity, in which the bottom of the second transverse hollow cylinder 104 is a side of the second transverse hollow cylinder 104 near the ground. By using the operation of the second auxiliary power apparatus 124 with the inclination of the second transverse hollow cylinder 104, the second material 128 can be moved in the second transverse hollow cylinder 104 and absorbs the heat emitted from the first material 126 in the first transverse hollow cylinder 102. Then, the second material 128 after being dried is moved to the second material outlet 122 and is outputted from the second material outlet 122.

The system 100 further includes a first material collecting device 130 and a second material collecting device 132. The first material collecting device 130 is disposed beneath the first material outlet 112 to collect the first material 126 after being cooled. The second material collecting device 132 is disposed beneath the second material outlet 122 to collect the second material 128 after being dried.

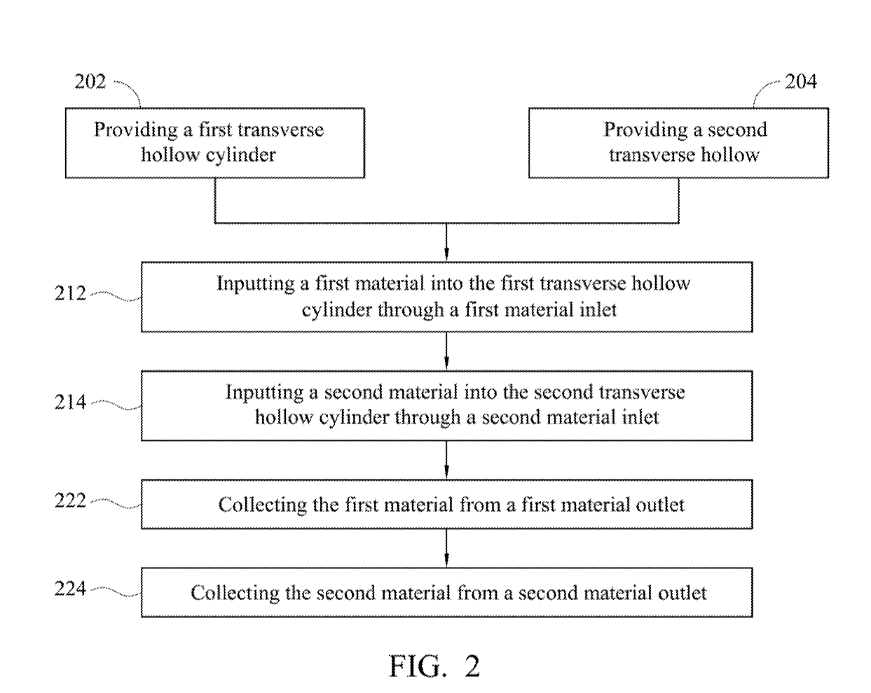

Referring to FIG. 1 and FIG. 2, FIG. 2 is a flow chart of a method for directly using waste heat generated from a high temperature solid according to one embodiment of this invention. At first, the first transverse hollow cylinder 102 is provided (step 202). As shown in FIG. 1, the first transverse hollow cylinder 102 has the first end 106 and the second end 108 opposite to the first end 106, the first material inlet 110, the first material outlet 112 and the first auxiliary power apparatus 114, in which the first end 106 of the first transverse hollow cylinder 102 is elevated higher than the second end 108 of the first transverse hollow cylinder 102.

On the other hand, the second transverse hollow cylinder 104 is provided (step 204). As shown in FIG. 1, the second transverse hollow cylinder 104 is disposed in the first transverse hollow cylinder 102 and has the third end 116, the fourth end 118 opposite to the third end 116, the second material inlet 120, the second material outlet 122 and the second auxiliary power apparatus 124, in which the fourth end 118 of the second transverse hollow cylinder 104 is elevated higher than the third end 116 of the second transverse hollow cylinder 104 and the third end 116 extends out of the first end 106 of the first transverse hollow cylinder 102.

Then, the first material 126 is inputted into the first transverse hollow cylinder 102 through the first material inlet 110 (step 212). As shown in FIG. 1, the first material inlet 110 is disposed near the first end 106 of the first transverse hollow cylinder 102 and on the top of the first transverse hollow cylinder 102. In an embodiment, the first material 126 is a high temperature material. After falling into the first transverse hollow cylinder 102 through the first material inlet 110, the first material 126 is moved in the first transverse hollow cylinder 102 and emits heat.

In the aforementioned method, the elevation of the first end 106 or the second end 108 of the first transverse hollow cylinder 102 can be further adjusted to change the inclined angle of the first transverse hollow cylinder 102, so as to change a moving speed of the first material 126 from the first material inlet 110 to the first material outlet 112. In the method, the first transverse hollow cylinder 102 can be vibrated or rotated to increase the moving speed of the first material 126 from the first material inlet 110 to the first material outlet 112.

Thereafter, the second material 128 is inputted into the second transverse hollow cylinder 104 through the second material inlet 120 (step 214). As shown in FIG. 1, the second material inlet 120 is disposed on the fourth end 118 of the second transverse hollow cylinder 104 for inputting the second material 128. In an embodiment, the first material 126 has a higher temperature than the second material 128. After falling into the second transverse hollow cylinder 104, the second material 128 with high moisture is moved in the second transverse hollow cylinder 104 and absorbs the heat emitted from the first material 126 in the first transverse hollow cylinder 102.

In the aforementioned method, the elevation of the third end 116 or the fourth end 118 of the second transverse hollow cylinder 104 can be further adjusted to change the inclined angle of the second transverse hollow cylinder 104, so as to change a moving speed of the second material 128 from the second material inlet 120 to the second material outlet 122. In the method, the second transverse hollow cylinder 104 can be vibrated or rotated to increase the moving speed of the second material 128 from the second material inlet 120 to the second material outlet 122.

Then, the first material 126 is collected from the first material outlet 112 (step 222). As shown in FIG. 1, the first material outlet 112 is disposed near the second end 108 and at the bottom of the first transverse hollow cylinder 102. In an embodiment, while being moved to the first material outlet 112, the high-temperature first material 126 keeps cooling down by emitting heat, and then is outputted from the first material outlet 112. In an embodiment, the first material 126 has a higher temperature in the first material inlet 110 than in the first material outlet 112.

Thereafter, the second material 128 is collected from the second material outlet 122 (step 224). As shown in FIG. 1, the second material outlet 122 is disposed on the third end 116 of the second transverse hollow cylinder 104, and is used for outputting the second material 128 after being dried. While being moved to the second material outlet 122, the second material 128 absorbs the heat emitted from the first material 126, and eventually, the second material 128 after being dried is outputted from the second material outlet 122. Therefore, the second material 128 has a greater degree of moisture in the second material inlet 120 than in the second material outlet 122.

Hereinafter, an example is provided for explaining the application of the present invention. In this example, the first material 126 has a specific heat of 0.85 kcal/kg and a temperature of 1100° C. in the first material inlet 110. The first material 126 is inputted into the first transverse hollow cylinder 102 through the first material inlet 110 at a flow rate of 50 kg/hr. Additionally, the second material 128 has a specific heat of 0.85 kcal/kg, a degree of moisture of 30% and a temperature of 25° C. in the second material inlet 120. The second material 128 is inputted into the second transverse hollow cylinder 104 through the second material inlet 120. Then, the first material 126 after being cooled and the second material 128 after being dried are collected respectively from the first material outlet 112 and the second material outlet 122. The temperature of the first material 126 in the first material outlet 112 is about 350° C., and the temperature of the second material 128 in the second material outlet 122 is about 250° C. If an effective utilization rate of heat is about 50%, the system of the present invention may dry 56 kg of the second material 128 per hour.

According to the aforementioned embodiments, the present invention has an advantage of effectively applying the waste heat generated during a cooling process of a solid product to a drying process of another product, thus directly using waste heat from the high temperature solid product.

Although the present invention has been described in considerable detail with reference to certain embodiments thereof, other embodiments are possible. Therefore, the spirit and scope of the appended claims should not be limited to the description of the embodiments contained herein.

What is claimed is:

1. A system for directly using waste heat from a high temperature solid, the system comprising:
a first transverse hollow cylinder having:
a first end and a second end opposite to the first end, wherein the first end is elevated higher than the second end;
a first material inlet disposed near the first end and on a top of the first transverse hollow cylinder for inputting a first material;
a first material outlet disposed near the second end and at a bottom of the first transverse hollow cylinder, wherein the bottom is located at a side of the first transverse hollow cylinder near a ground, for outputting the first material which has been cooled; and
a first auxiliary power apparatus connected to the first transverse hollow cylinder for vibrating or rotating the first transverse hollow cylinder; and
a second transverse hollow cylinder disposed in the first transverse hollow cylinder, the second transverse hollow cylinder having:
a third end and a fourth end opposite to the third end, wherein the fourth end is elevated higher than the third end, and the third end extends out of the first end of the first transverse hollow cylinder;
a second material inlet disposed on the fourth end for inputting a second material;
a second material outlet disposed on the third end for outputting the second material which is dried; and
a second auxiliary power apparatus connected to the second transverse hollow cylinder for vibrating or rotating the second transverse hollow cylinder.

2. The system of claim 1, further comprising:
a first material collecting device disposed beneath the first material outlet; and
a second material collecting device disposed beneath the second material outlet.

3. The system of claim 1, wherein the first transverse hollow cylinder further comprises:
a first rotation pivot disposed at a bottom of the first end or the second end for adjusting an elevation of the first end or an elevation of the second end.

4. The system of claim 1, wherein the second transverse hollow cylinder further comprises:
a second rotation pivot disposed at a bottom of the third end or the fourth end for adjusting an elevation of the third end or an elevation of the fourth end.

5. The system of claim 1, further comprising:
a heat insulation sleeve covering at least one portion of an outer wall of the first transverse hollow cylinder.

6. A method for directly using waste heat from a high temperature solid, the method comprising:
providing a first transverse hollow cylinder having a first end, a second end opposite to the first end, a first material inlet and a first material outlet, wherein the first end is elevated higher than the second end, and the first material inlet disposed near the first end and on a top of the first transverse hollow cylinder, and the first material outlet disposed near the second end and at a bottom of the first transverse hollow cylinder;
providing a second transverse hollow cylinder, the second hollow cylinder having a third end a fourth end opposite to the third end, a second material inlet and a second material outlet, wherein the fourth end is elevated higher than the third end, the third end extending out of the first end of the first transverse hollow cylinder, and the second material inlet is disposed on the fourth end, and the second material outlet is disposed on the third end;
inputting a first material into the first transverse hollow cylinder through the first material inlet;
inputting a second material into the second transverse hollow cylinder through the second material inlet, wherein the first material has a higher temperature than the second material;
collecting the first material from the first material outlet, wherein the first material in the first material inlet has a higher temperature than the first material in the first material outlet; and
collecting the second material from the second material outlet, wherein the second material in the second material inlet has a degree of moisture greater than the second material in the second material outlet.

7. The method of claim 6, further comprising:
adjusting a elevation of the first end or the second end of the first transverse hollow cylinder to change a moving speed of the first material from the first material inlet to the first material outlet.

8. The method of claim 6, further comprising:
vibrating or rotating the first transverse hollow cylinder to accelerate moving the first material from the first material inlet to the first material outlet.

9. The method of claim 6, further comprising:
modulating a height of the given position of the third end or the fourth end of the second transverse hollow cylinder to change a moving speed of the second material from the second material inlet to the second material outlet.

10. The method of claim 6, further comprising:
vibrating or rotating the second transverse hollow cylinder to accelerate moving the second material from the second material inlet to the second material outlet.
